(19) United States
(12) Patent Application Publication
(10) Pub. No.: US 2021/0085441 A1
(43) Pub. Date: Mar. 25, 2021

(54) SPERM INJECTION TUBE FOR ARTIFICIAL INSEMINATION OF SWINE

(71) Applicant: ENN CHIH CO., LTD., TAOYUAN CITY (TW)

(72) Inventor: Eddie CHEN, Kaohsiung City (TW)

(73) Assignee: ENN CHIH CO., LTD., TAOYUAN CITY (TW)

(21) Appl. No.: 16/717,223

(22) Filed: Dec. 17, 2019

(30) Foreign Application Priority Data
Sep. 20, 2019 (TW) 108134102

(51) Int. Cl. A61D 19/02

(52) U.S. Cl. CPC A61D 19/027

(57) ABSTRACT

A sperm injection tube for artificial insemination of swine has a tube and a plug mounted on an end of the tube. The plug has a plug body, a guiding portion, and a blocking portion. The guiding portion is formed around the plug body and has multiple guiding fins near the injection hole. The blocking portion is formed around the plug body and has at least one blocking fin near the connecting hole. Each guiding fin is umbrella-shaped and flexible. When inserting the sperm injection tube into the uterus, the guiding fins are concentrated toward the plug body to led the plug to easily pass through the cervix. The blocking portion block the cervix to prevent the semen flowing out and to keep the tube from being pushed out to raise the conception rate of the sow.

### BACKGROUND OF THE INVENTION

### 1. Field of the Invention

The present invention relates to a sperm injection tube for artificial insemination of swine, and more particularly to a sperm injection tube, which can be easily inserted through a cervix of a sow, can prevent boar semen flowing out after injection, and can prevent the tube sliding out from the cervix of the sow.

### 2. Description of Related Art

Conventional plugs of sperm injection tubes for artificial insemination of swine include two types, one is spiral plug, and the other is blocking plug. With reference to FIG. 5, a conventional sperm injection tube 80 with a spiral plug 82 has a tube 81 and a plug 82. The plug 82 surrounds an end of the tube 81 and has a body 83, a tip protrusion 84, and a spiral protrusion 85. The body 83 is mounted on the tube 81 and has a through hole 86 formed through the body 83 and communicating with the tube 81. The tip protrusion 84 protrudes from the body 83 at a position away from the tube 81. The spiral protrusion 85 spirally surrounds and protrudes from the outer surface of the body 83. To artificially inseminate a sow, the plug 82 is slowly inserted into the vagina of the sow. The tip protrusion 84 of the plug 82 firstly contacts the surface of the cervix to open folds of the surface of the cervix while passing through the cervix of the sow. The spiral protrusion 85 supports the folds of the surface of the cervix to keep a passage of the cervix open for the body 83 of the plug 82 to extend through. After the plug 82 is inserted in the uterus, the tube 81 is connected to a container carrying boar semen. The boar semen flows through the tube 81 and the plug 82 and is injected into the uterus of the sow via the through hole 86 of the plug 82 to complete artificial insemination in the sow.

However, while the sperm injection tube is being inserted, the tip protrusion 84 of the spiral plug 82 is easily squeezed by contacting the cervix or the uterus of the sow, and the through hole 86 of the plug 82 will be squeezed to block the injection of semen. The sow may feel uncomfortable and start to struggle because of poking of the tip protrusion 84. At this moment, the vagina of the sow will be prone to injury by the sperm injection tube 80. In addition, during the semen injection process, the contractions of the cervix of the sow, which are caused by poking, may cause the semen to flow out from the cervix to the vagina. The spiral protrusion 85 of the plug 82 cannot block the semen from flowing out. The flowing out semen is wasted. The volume of the semen injected in the uterus is reduced, leading to the failure of conception.

With reference to FIG. 6, a conventional sperm injection tube 90 with a blocking plug 92 can prevent the boar semen flowing out from the cervix of the sow. The sperm injection tube 90 has a tube 91 and a plug 92. The plug 92 surrounds an end of the tube 91 and has a body 93 and a blocking surface 94. The body 93 is mounted on the tube 91 and has a through hole formed through the body 93 and communicating with the tube 91. The blocking surface 94 is formed in a front end of the body 93. After the plug 91 is inserted into the uterus of the sow, even with the contraction of the cervix, the injection boar semen is blocked by the blocking surface 94. Thus, the boar semen injected into the uterus is prevented from flowing out to keep the injection volume of the boar semen. The conception rate of the sow can be raised.

However, when the blocking plug 92 is being inserted, the blocking surface 94 tightly abuts against the inner surface of the cervix to prevent the boar semen from flowing out. The passage of the cervix, where the blocking surface 94 extends through, is opened, and the sow will feel extremely uncomfortable, causing intense contraction of the cervix. The sperm injection tube 90 with the blocking plug 92 will be pushed out from the cervix of the sow by strong contraction force. The plug 92 may scrape the surface of the cervix easily during inserting or pulling out, and the risk of infection of the sow is increased.

To overcome the shortcomings, the present invention tends to provide a sperm injection tube for artificial insemination of swine to mitigate or obviate the aforementioned problems.

### SUMMARY OF THE INVENTION

The main objective of the invention is to provide a sperm injection tube for artificial insemination of swine. The sperm injection tube can prevent the boar semen flowing out from the cervix of the sow to raise the conception rate of the sow, can reduce the discomfort of the sow while inserting the sperm injection tube to avoid the sperm injection tube being pushed out by intense contraction, and can reduce scraping of the surface of the cervix while inserting the sperm injection tube.

A sperm injection tube applied for artificial insemination of swine comprises a tube and a plug. The plug has a plug body, a guiding portion, and a blocking portion. The plug body is tubular and has a connecting hole formed in one of the ends of the plug body and extending along the plug body and an injection hole formed in the other end of the plug body and communicating with the connecting hole. The guiding portion is formed around the plug body at a position near the injection hole and has multiple guiding fins arranged along the plug body at spaced intervals and protruding from the plug body near the injection hole. Each guiding fin is umbrella-shaped, bends toward the connecting hole, and is flexible and invertible. The blocking portion is formed around the plug body at a position near the connecting hole and has at least one blocking fin protruding from the plug body near the connecting hole. A diameter of the at least one blocking fin is larger than and equal to a maximum of outer diameters of the guiding fins. The tube has a tube body. An end of the tube body is mounted in the connecting hole of the plug.

Other objects, advantages and novel features of the invention will become more apparent from the following detailed description when taken in conjunction with the accompanying drawings.

### BRIEF DESCRIPTION OF THE DRAWINGS

FIG. 1 is a side view of an embodiment of a plug of a sperm injection tube for artificial insemination of swine in accordance with the present invention;

FIG. 2 is a side view of the embodiment of the sperm injection tube for artificial insemination of swine with the plug in FIG. 1;

FIG. 3 is an enlarged cross sectional side view of the sperm injection tube in FIG. 2;

FIG. 4 is an enlarged side view of another embodiment of a sperm injection tube in accordance with the present invention;

FIG. 5 is a side view of a conventional sperm injection tube for artificial insemination of swine; and

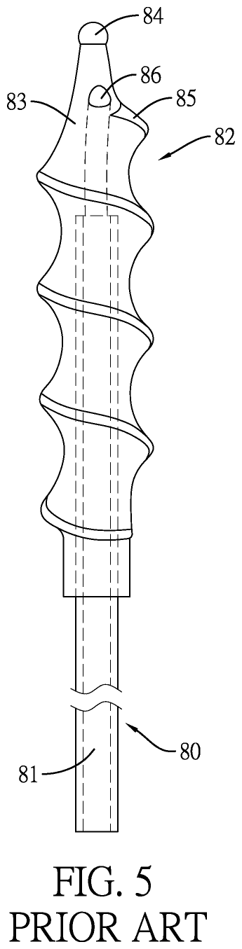

FIG. 6 is a side view of another conventional sperm injection tube for artificial insemination of swine.

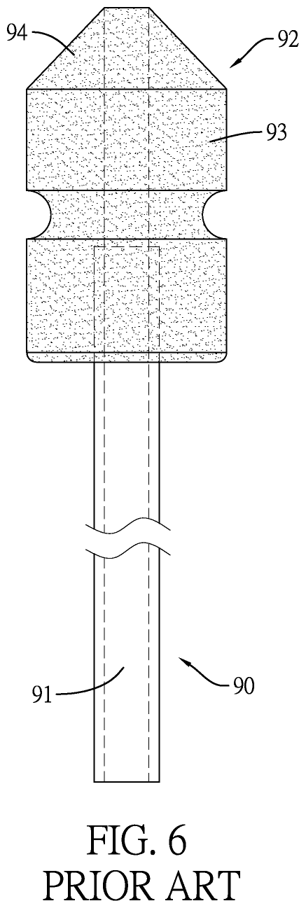

### DETAILED DESCRIPTION OF PREFERRED EMBODIMENT

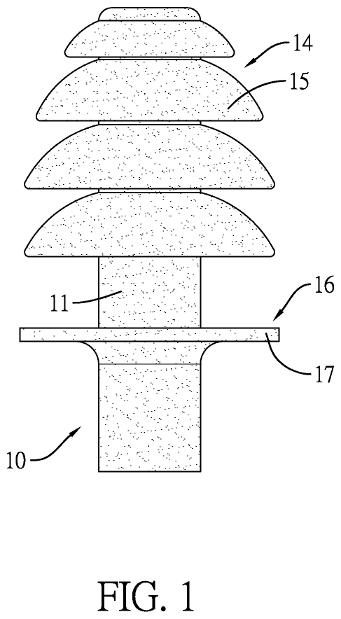

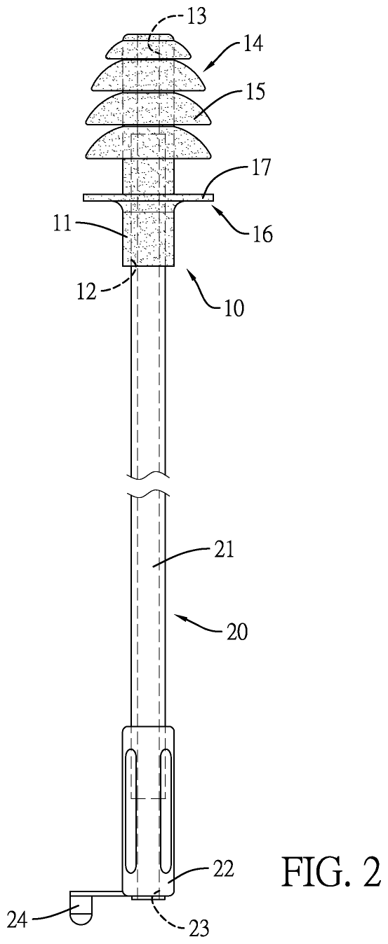

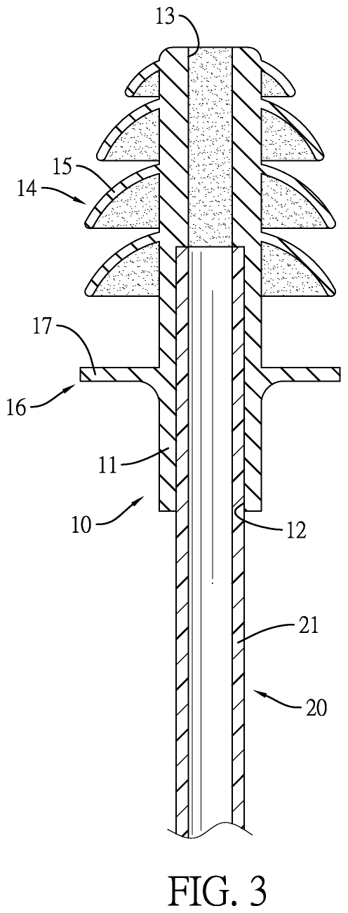

With reference to FIGS. 1 to 3, an embodiment of a sperm injection tube for artificial insemination of swine in accordance with the present invention has a plug 10 and a tube 20. The plug 10 has a plug body 11, a guiding portion 14, and a blocking portion 16.

The plug body 11 is tubular and has a connecting hole 12 and an injection hole 13. The connecting hole 12 is formed in an end of the plug body 11 and extends along the plug body 11. The injection hole 13 is formed in the other end of the plug body 11 and communicates with the connecting hole 12. The diameter of the injection hole 13 is smaller than the diameter of the connecting hole 12.

The guiding portion 14 is formed around and protrudes from the plug body 11 at a positon near the injection hole 13. The guiding portion 14 has multiple guiding fins 15. The guiding fins 15 are arranged along the plug body 11 at spaced intervals near the injection hole 13. Each guiding fin 15 is umbrella-shaped, bends toward the connecting hole 12, and has a cavity formed in an end of the guiding fin 15 facing the connecting hole 12, such as a hollow upper half of a sphere having a convex surface facing the injection hole13 and a concave surface facing the connecting hole 12. The cavity of the guiding fin 15 is gradually larger toward the connecting hole 12. The outer diameters of the guiding fins 15 gradually increase from the injection hole 13 toward the connecting hole 12. The outer diameter of one of each two adjacent guiding fins 15, which is adjacent to the injection hole 13, is smaller than the outer diameter of the other guiding fin 15, which is adjacent to the connecting hole 12. Thus, the guiding fins 15 are arranged in a conical shape. Each guiding fin 15 has a low degree of hardness, and is flexible and invertible.

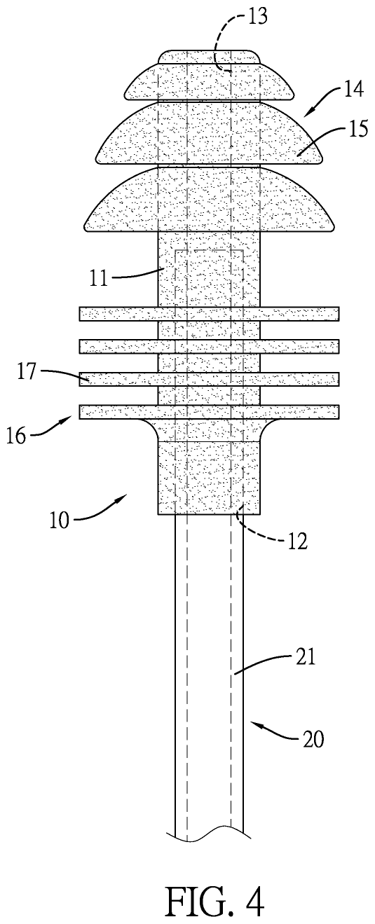

The blocking portion 16 is formed around and protrudes from the plug body 11 at a position near the connecting hole 12. The blocking portion 16 has at least one blocking fin 17. The blocking fin 17 is a circular plate and protrudes from the plug body 11 near the connecting hole 12. The diameter of the blocking fin 17 is larger than or equal to a maximum of the outer diameters of the guiding fins 15. The degree of hardness of the blocking fin 17 is higher than the degree of hardness of each guiding fin 15. With reference to FIG. 4, in another embodiment, the blocking portion 16 has multiple blocking fins 17 arranged along the plug body 11 at spaced intervals and being perpendicular to an outer surface of the plug body 11.

With reference to FIGS. 1 to 3, the tube 20 has a tube body 21 and a connecting sleeve 22. The plug 10 is mounted on another end of the tube body 21. The plug body 11 is mounted on and surrounds the end of the tube body 21. An end of the tube body 21 is mounted in the connecting hole 12. The injection hole 13 communicates with the tube body 21. The plug 10 is selected from flexible and elastic materials. The connecting sleeve 22 is mounted on the end of the tube body 21 away from the tube body 21. The connecting sleeve 22 has a sleeve hole 23 communicating with the tube body 21. The tube 20 further has a closing block 24 connected to the connecting sleeve 22 and is detachably mounted in the sleeve hole 23 to close the sleeve hole 23.

With reference to FIGS. 1 to 3, to artificially inseminate a sow with the sperm injection tube, the plug 10 is slowly inserted into the vagina of the sow. While the plug 10 is passing through the cervix of the sow, the guiding portion 14 firstly contacts the surface of the cervix. The guiding fins 15 of the guiding portion 14 approach the plug body 11 while contacting the surface of the cervix. The outer diameters of the guiding fins 15 are reduced while the guiding fins 15 are passing through the cervix. The guiding fins 15 contact the surface of the cervix such that the plug body 11 can be pushed into the uterus easily. During the insertion, the plug 10 pushes folds of the surface of the cervix toward the uterus to open a passage. Then, the blocking fin 17 of the blocking portion 16 blocks the opening of the cervix. After the plug 10 is inserted in the uterus, the tube 20 is connected to a container containing boar semen via the connecting sleeve 22. The boar semen flows through the tube body 21 and the plug 10 and is injected into uterus of the sow via the injection hole 13 of the plug 10 to complete artificial insemination in the sow.

Because the guiding fins 15 are umbrella-shaped, bend toward the connecting hole 12, and are flexible and invertible, the plug 10 can be smoothly inserted into the cervix without scraping the surface of the cervix. When pulling out the plug 10 from the cervix, the guiding fins 15 contact the surface of the cervix and can be inverted by the surface of the cervix with the pull-out force. The plug 10 can be smoothly pulled out from the cervix without scraping the surface of the cervix. The risk of injury and infection of the sow can be reduced.

Because hardness of the blocking fin 17 is higher than hardness of each of the guiding fin 15, the blocking capability of blocking fin 17 is enhanced. The blocking fin 17 abuts against the outer surface or the inner surface of the cervix to block the opening of the cervix. The boar semen can be kept in the uterus by the blocking of the blocking fin 17 and may not flow to the vagina during contraction of the cervix. The conception rate of the sow can be raised. In addition, if the tube 20 is pushed by intense contraction of the cervix, the blocking fin 17 of the plug 10 mounted in the cervix can prevent the plug 10 easily dropping out of the cervix to hold the tube 20. The amount of the blocking fins 17 of the blocking portion 16 may be arranged by the user's requirements. With reference to FIG. 4, the blocking portion 16 may have four blocking fins 17 to enhance the blocking capability of the plug 10 for preventing the boar semen flowing out and the plug 10 dropping out. The blocking fins 17 are arranged along the plug body 11 at spaced intervals and are perpendicular to the outer surface of the plug body 11 for tightly abutting against the surface of the cervix.

The material of the plug 10 is selected from flexible and elastic materials to protect the sow from cervix scraping. Because the injection hole 13 is smaller than the connecting hole 12, when the tube body 21 is mounted in the connecting hole 12, the end of the tube body 21 may not protrude from the injection hole 13 and is kept in the plug 10 to prevent the sow from poking by the end of the tube body 21 while pushing the tube body 21 into the vaginal. The connecting sleeve 22 of the tube 20 may assist the user to hold the tube body 21 and push the plug 10 into the vagina. The closing block 24 can be mounted in and close the sleeve hole 23. Thus, the injection boar semen may not flow out of the vagina via the tube body 21, therefore raising the conception rate.

With such arrangements, the guiding fins 15 can be guided toward the plug body 11 by contacting the surface of the cervix while inserting the plug 10. The plug 10 can be easily inserted into the uterus to reduce discomfort of the sow while inserting the sperm injection tube. The blocking fin 17 of the blocking portion 16 can abut against the surface of the cervix and block the cervix to prevent the boar semen flowing out from the cervix. The boar semen can be kept in the uterus to raise the conception rate. When the sperm injection tube is pushed by the intense contraction, the plug 10 can be kept in the cervix by the blocking fin 17 blocking the cervix to prevent the sperm injection tube from being pushed out. The user can hold the connecting sleeve 22 and the tube body 21 to insert the plug 10 into the vagina to easily complete the artificial insemination in the sow.

What is claimed is:

1. A sperm injection tube applied for artificial insemination of swine comprising:
a plug having
a plug body being tubular and having two ends;
a connecting hole formed in one of the ends of the plug body and extending along the plug body; and
an injection hole formed in the other end of the plug body and communicating with the connecting hole;
a guiding portion formed around the plug body at a position near the injection hole and having
multiple guiding fins arranged along the plug body at spaced intervals and protruding from the plug body near the injection hole, each guiding fin being umbrella-shaped, bending toward the connecting hole, having a cavity formed in an end of the guiding fin facing the connecting hole, and being flexible and invertible; and
a blocking portion formed around the plug body at a position near the connecting hole and having
at least one blocking fin protruding from the plug body near the connecting hole, a diameter of the at least one blocking fin being larger than or equal to a maximum of outer diameters of the guiding fins; and
a tube having
a tube body and an end of the tube body mounted in the connecting hole of the plug.

2. The sperm injection tube as claimed in claim 1, wherein the blocking portion of the plug has multiple blocking fins arranged along the plug body at spaced intervals and being perpendicular to the plug body.

3. The sperm injection tube as claimed in claim 1, wherein a degree of hardness of the at least one blocking fin is higher than a degree of hardness of each of the guiding fins.

4. The sperm injection tube as claimed in claim 2, wherein a degree of hardness of each of the blocking fins is higher than a degree of hardness of each of the guiding fins.

5. The sperm injection tube as claimed in claim 1, wherein a diameter of the injection hole is smaller than a diameter of the connecting hole.

6. The sperm injection tube as claimed in claim 2, wherein a diameter of the injection hole is smaller than a diameter of the connecting hole.

7. The sperm injection tube as claimed in claim 3, wherein a diameter of the injection hole is smaller than a diameter of the connecting hole.

8. The sperm injection tube as claimed in claim 4, wherein a diameter of the injection hole is smaller than a diameter of the connecting hole.

9. The sperm injection tube as claimed in claim 1, wherein the outer diameters of the guiding fins gradually increase from the injection hole toward the connecting hole.

10. The sperm injection tube as claimed in claim 2, wherein the outer diameters of the guiding fins gradually increase from the injection hole toward the connecting hole.

11. The sperm injection tube as claimed in claim 3, wherein the outer diameters of the guiding fins gradually increase from the injection hole toward the connecting hole.

12. The sperm injection tube as claimed in claim 4, wherein the outer diameters of the guiding fins gradually increase from the injection hole toward the connecting hole.

13. The sperm injection tube as claimed in claim 5, wherein the outer diameters of the guiding fins gradually increase from the injection hole toward the connecting hole.

14. The sperm injection tube as claimed in claim 6, wherein the outer diameters of the guiding fins gradually increase from the injection hole toward the connecting hole.

15. The sperm injection tube as claimed in claim 7, wherein the outer diameters of the guiding fins gradually increase from the injection hole toward the connecting hole.

16. The sperm injection tube as claimed in claim 8, wherein the outer diameters of the guiding fins gradually increase from the injection hole toward the connecting hole.

17. The sperm injection tube as claimed in claim 1, wherein the tube has
a connecting sleeve mounted on another end of the tube body away from the plug and having a sleeve hole communicating with the tube body; and
a closing block connected to the connecting sleeve and detachably mounted in the sleeve hole of the connecting sleeve to close the sleeve hole of the connecting sleeve.

18. The sperm injection tube as claimed in claim 2, wherein the tube has
a connecting sleeve mounted on another end of the tube body away from the plug and having a sleeve hole communicating with the tube body; and
a closing block connected to the connecting sleeve and detachably mounted in the sleeve hole of the connecting sleeve to close the sleeve hole of the connecting sleeve.

19. The sperm injection tube as claimed in claim 3, wherein the tube has
a connecting sleeve mounted on another end of the tube body away from the plug and having a sleeve hole communicating with the tube body; and
a closing block connected to the connecting sleeve and detachably mounted in the sleeve hole of the connecting sleeve to close the sleeve hole of the connecting sleeve.

20. The sperm injection tube as claimed in claim 4, wherein the tube has
a connecting sleeve mounted on another end of the tube body away from the plug and having a sleeve hole communicating with the tube body; and
a closing block connected to the connecting sleeve and detachably mounted in the sleeve hole of the connecting sleeve to close the sleeve hole of the connecting sleeve.
